(19) United States
(12) Patent Application Publication
(10) Pub. No.: US 2023/0059571 A1
(43) Pub. Date: Feb. 23, 2023

(54) CATHODE MATERIAL STABILIZATION

(71) Applicants: FORD GLOBAL TECHNOLOGIES, LLC, Dearborn, MI (US); WORCESTER POLYTECHNIC INSTITUTE, Worcester, MA (US)

(72) Inventors: Renata Michaela ARSENAULT, Plymouth, MI (US); Yan WANG, Acton, MA (US); Luqman AZHARI, Worcester, MA (US)

(21) Appl. No.: 17/405,382

(22) Filed: Aug. 18, 2021

(51) Int. Cl. H01M 4/505; H01M 4/525

(52) U.S. Cl. CPC H01M 4/505; H01M 4/525; H01M 2004/028

(57) ABSTRACT

A method of stabilizing Nickel-rich (NMC) cathode materials includes mixing a feedstock of transition metal sulfates, ammonia, and a basic solution to under bubbling of an inert gas to form a reaction solution, precipitating transition metal hydroxide particles from the reaction solution over a first period of time to precipitate the transition metal hydroxide particles therein to form a metal sulfate solution. The method further includes altering the pH of the metal sulfate solution, supplying a Mn-rich feedstock to the metal sulfate solution to form a Mn-rich solution, and precipitating Mn-rich hydroxide nanoparticles from the Mn-rich solution onto surfaces of the transition metal hydroxide particles over a second period of time to form a heterogeneous precursor.

### TECHNICAL FIELD

The present application is directed to a method of stabilizing cathode materials, and more particularly, a two-step co-precipitation process to coat the materials during the precursor stage.

### BACKGROUND

Nickel-rich (Ni-rich) cathode materials, such as Lithium-Nickel-Manganese-Cobalt-Oxide (NMC) materials (e.g., NMC811 (LiNi_{0.8}Mn_{0.1}Co_{0.1}O₂)), are materials which can be used for Li-ion battery cathodes, which offer higher specific capacity (e.g., 200 mAh/g vs. 140 mAh/g for NMC111) at low cost due to its low cobalt content. Conventional nickel-rich cathodes may undergo capacity fading due to causes such as Ni²⁺ and Li⁺ cation mixing during cycling, surface transformations (e.g., from layered to spinel and rock-salt ordering), onset of thermal runaway, nickel-electrolyte reactivity (e.g., reactivity of Ni⁴⁺ followed by the release of lattice oxygen), and intergranular cracking, especially at high temperatures and voltage (e.g., voltage greater than 4.3 V vs Li/Li+). Although capacity fading has generally curbed implementation of nickel-rich cathode materials, stabilization of nickel-rich materials has improved its incorporation in Li-ion battery cathodes.

Since many mechanistic drawbacks are surface initiated, conventional nickel-rich cathode materials typically include stabilization features focused on reducing contact between the Ni-rich material and electrolyte by having an electrochemically stable barrier material on the outer surface of the Ni-rich material. Examples of stable barrier materials include alumina oxides (e.g., Al₂O₃ coating), conductive polymers, gradient or shell NMC material with surface compositions of lower Ni/Mn ratios, and spinel compounds. Furthermore, Mn-rich materials are typically favored for their low toxicity and cost, and high chemical stability. However, established methods that utilize protective coatings, especially Mn-rich spinel, involve applying coatings to the sintered cathode via a second sintering step on the already sintered powder. These stabilizations are typically conducted using a small batch (i.e., non-scalable) process such as atomic layer deposition, rotary evaporation, etc., which are not practical as high throughput industrial processes.

### SUMMARY

According to one or more embodiments, a method of stabilizing Nickel-rich (NMC) cathode materials includes mixing a feedstock of transition metal sulfates, ammonia, and a basic solution to under bubbling of an inert gas to form a reaction solution, precipitating transition metal hydroxide particles from the reaction solution over a first period of time to precipitate the transition metal hydroxide particles from a metal sulfate solution. The method further includes altering the pH of the metal sulfate solution, supplying a Mn-rich feedstock to the metal sulfate solution to form a Mn-rich solution, and precipitating Mn-rich hydroxide nanoparticles from the Mn-rich solution onto surfaces of the transition metal hydroxide particles over a second period of time to form a heterogeneous precursor.

a method of stabilizing Nickel-rich (NMC) cathode materials includes mixing a feedstock of transition metal sulfates, ammonia, and a basic solution under bubbling of an inert gas to precipitate transition metal hydroxide particles from the reaction solution over a first period of time. The method further includes altering the pH of the diluted metal sulfate solution, supplying a Mn-rich feedstock to the diluted metal sulfate solution to form a Mn-rich solution, and precipitating Mn-rich hydroxide nanoparticles from the Mn-rich solution onto surfaces of the transition metal hydroxide particles over a second period of time to form a heterogeneous precursor. The heterogenous precursor can be lithiated and sintered to form a nickel-rich cathode material having a stabilized coating thereon.

According to at least one embodiment, the precipitating step may include exposing the heterogeneous precursor to air to transform the Mn-rich hydroxide nanoparticles to an Mn-rich precursor nanoparticle. In at least one embodiment, the Mn-rich precursor nanoparticles may be Mn₂₇Co_{0.3}O₄, the Mn-rich hydroxide nanoparticles may be Mn_{0.9}Co_{0.1}(OH)₂, and the transition metal hydroxide particles may be (Ni_{0.8}Mn_{0.1}Co_{0.1})(OH)₂. In one or more embodiments, the precipitating may be conducted via a batch process such that the first period of time includes a precipitation period and an aging period such that the reaction solution forms a diluted metal sulfate solution with the transition metal hydroxide particles therein during the aging period. In at least another embodiment, the first period of time and the second period of time may occur in separate fluidly connected reactor vessels as a respective first and second residence time of a continuous process. In one or more embodiments, the inert gas may be nitrogen and the basic solution may be sodium hydroxide. In at least one embodiment, the altering the pH may be via addition of a basic feedstock solution more concentrated than the initial basic solution.

According to one or more embodiments, a method of stabilizing Nickel-rich (NMC) cathode materials includes mixing a feedstock of transition metal sulfates, ammonia, and a basic solution to under bubbling of an inert gas to form a reaction solution at a first pH, and precipitating transition metal hydroxide particles from the reaction solution over a first period of time to form a dilute metal sulfate solution. The method further includes altering the first pH of the metal sulfate solution to a second pH, higher than the first pH, supplying a Mn-rich feedstock to the metal sulfate solution to form a Mn-rich solution, and precipitating Mn-rich hydroxide nanoparticles from the Mn-rich solution onto surfaces of the transition metal hydroxide particles over a second period of time. The method also includes exposing the Mn-rich hydroxide nanoparticles to air to form a heterogeneous precursor, and lithiating the heterogeneous precursor with a lithium source to form a stabilized nickel-rich material.

According to at least one embodiment, the heterogeneous precursor may include a Mn-rich precursor coated on a transition metal hydroxide particle. In at least one embodiment, altering the pH may include adding a basic feedstock more concentrated than the basic solution to the diluted Mn-rich sulfate solution to change the pH to the second pH. In one or more embodiments, the precipitating steps may be via a batch process such that the first period of time and second period of time occur within the same reaction vessel. In a further embodiment, the first period of time may include a precipitation period and an aging period such that the reaction solution forms a diluted Mn-rich sulfate solution with the transition metal hydroxide particles therein during the aging period. In at least one embodiment, the Mn-rich hydroxide nanoparticles may be Mn_{0.9}Co_{0.1}(OH)₂ and the Mn-rich precursor may be Mn_{2.7}Co_{0.3}O₄. In one or more embodiments, the stabilized nickel-rich material may be a Mn-rich spinel coated NMC811. In at least one embodiment, the transition metal hydroxide particles may be NMC811 precursor particles having the formula Ni_{0.8}Mn_{0.1}Co_{0.1}(OH)₂. In at least one embodiment, the Mn-rich feedstock may be doped with cobalt.

According to one or more embodiments, a method of stabilizing Nickel-rich NMC cathode materials includes mixing a feedstock of transition metal sulfates, ammonia, and sodium hydroxide solution to under bubbling of an inert gas to precipitate transition metal hydroxide particles from the reaction solution over a first period of time at a first pH to form a metal sulfate solution, and altering the pH to a second pH higher than the first by adding a sodium hydroxide feedstock more concentrated than the sodium hydroxide solution to the metal sulfate solution. The method further includes supplying a Mn-rich feedstock to the metal sulfate solution to form a Mn-rich solution, and precipitating Mn-rich hydroxide nanoparticles from the Mn-rich solution onto surfaces of the transition metal hydroxide particles over a second period of time. The method also includes exposing the Mn-rich hydroxide nanoparticles to air to form a heterogeneous precursor having an Mn-rich precursor coated on the transition metal hydroxide particles; and lithiating the heterogeneous precursor with a lithium source to form a stabilized nickel-rich material.

According to at least one embodiment, the precipitating steps may be conducted within the same reactor vessel as a batch process such that the first period of time includes a precipitation time period and an aging time period. In at least another embodiment, the precipitating steps may be conducted as a continuous process such that the first period of time is within a first reactor and the second period of time is in a second reactor, fluidly connected to the first. In one or more embodiments, the first pH may be 10-12 and the second pH may be 11-13.

### BRIEF DESCRIPTION OF THE DRAWINGS

FIG. 1 is a process flow diagram of a conventional stabilization method;

FIG. 2 is a process flow diagram of a stabilization method, according to an embodiment;

FIG. 3 is a process schematic showing a stabilization method, according to an embodiment;

FIG. 4 is a process schematic showing a stabilization method, according to another embodiment;

FIG. 5A is a schematic illustration of a stabilization method, according to an embodiment; and

FIG. 5B is a schematic illustration further depicting the stabilization method of FIG. 5A according to a further embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in any examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. As used herein, the term “about” means that the amount or value in question may be the specific value designated or some other value in its neighborhood. The term “about” or “generally” denoting a certain value is intended to denote a range within +/−5% of the value. As one example, the phrase “about 100” denotes a range of 100+/−5, i.e. the range from 95 to 105. When the term “about” or “generally” is used, it can be expected that similar results or effects according to the invention can be obtained within a range of +/−5% of the indicated value. It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended aspects, the singular form “a,” “an,” and “the” comprise plural referents unless the context clearly indicates otherwise. For example, reference to a component in the singular is intended to comprise a plurality of components.

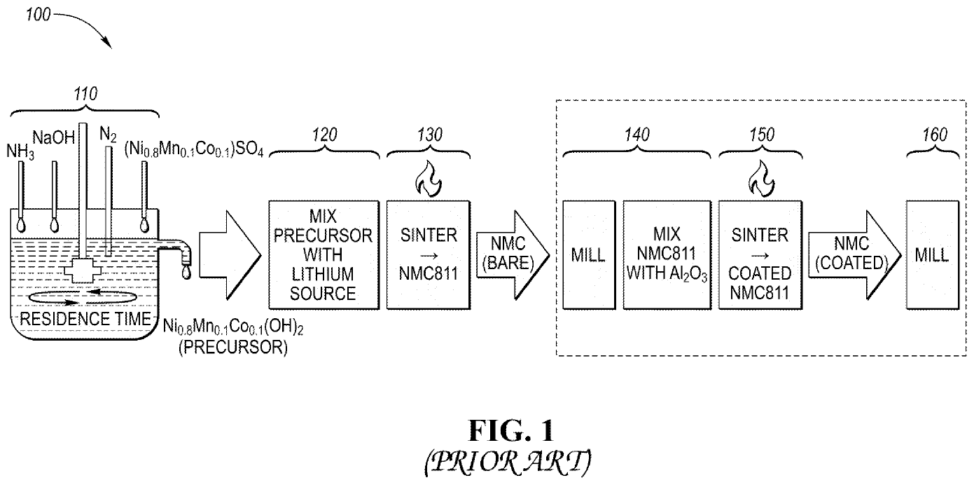

Referring to FIG. 1, an example of a conventional dry coating process 100 for forming a stabilized nickel-rich cathode material is shown. Although specifically shown for forming an NMC811 material coated with an alumina oxide coating, the general steps of the conventional stabilization method apply to other Ni-rich materials as well. At step 110, the Ni-rich reactant (e.g., (Ni_{0.8}Mn_{0.1}Co_{0.1})SO₄) is reacted with NH₃ and NaOH reacted under N₂ gas in a batch reactor to form a Ni-rich precursor material (e.g., Ni_{0.8}Mn_{0.1}Co_{0.1}(OH)₂ in the example of FIG. 1). This Ni-rich precursor material is then mixed with a lithium source at step 120 for lithiation, and sintered at step 130, to form the NMC material (e.g., NMC811), via suitable known methods for lithiation and sintering. This sintered NMC material is pristine, meaning the surface of the NMC material is bare or otherwise unmodified. At step 140, the sintered NMC material is milled and mixed with a stabilization coating (e.g., Al₂O₃), which is sintered again in a second sintering step at step 150 to form the coated NMC cathode material (e.g., coated NMC811) for milling at step 160 into the cathode powder. Other conventional coating processes include mixing and deposition of the stabilization in coating via rotary evaporation or atomic layer deposition. For example, conventional solutions of stabilizing Ni-rich cathode materials with a Mn-rich spinel coating include the sintered cathode being stirred in a solution with Mn and/or Li salts under heating until all solvent is evaporated. The conventional process diagrammed in FIG. 1 and other conventional processes described above area generally energy intensive and not practically scalable.

According to one or more embodiments, a method of co-precipitating a heterogeneous precursor material including a transition metal hydroxide precursor, such as, and hereinafter interchangeably, a Nickel-rich precursor (e.g., a precursor for nickel rich LiNiₓMn_{1-x-y}Co_{y}O₂ where x>0.6, or a precursor for LiNi_{0.8}Mn_{0.1}Co_{0.1}O₂, commonly referred to as “NMC811,” such as Ni_{0.8}Mn_{0.1}Co_{0.1}(OH)₂ or other Nickel-rich cathode material) coated with particles of a stabilization material, such as an Mn-material (e.g., Mn_{2.7}Co_{0.3}O₄) via a two-step reaction, such that upon sintering during cathode preparation, the precursor forms a crystalline NMC material (e.g., NMC811) coated with a thin layer of an Mn-rich spinel thereon. In some examples, the Mn-rich thin layer spinel may be LiMn_{1.8}Co_{0.2}O₄. Although NMC will be discussed hereinafter, and particular NMC compositions may be referred to, this is not intended to be limiting and the processing described herein is applicable to any suitable Nickel-rich cathode material, and thus may be referred to interchangeably. As such, the method results in an active material precursor coated with the stabilizing material precursor (i.e., the spinel precursor), which can be subsequently lithiated and sintered (only after the lithiation stage) to form the stabilized active material. The method of co-precipitating the heterogenous precursor material allows for high throughput through the processing system at lower costs, while maintaining improvements in capacity retention for stabilized Ni-rich materials. Mn-rich compositions provide high chemical stability at low cost and toxicity. For example, Mn-rich materials arrange in the spinel Fd3m structure, which contain an interstitial network for lithium diffusion, as opposed to higher impedance materials.

Furthermore, stabilization methods using solely conventional co-precipitation usually involves synthesis of core-shell or gradient structures in which all components in the reactor are hydroxide precursors to a layered NMC material, with alterations only in the Ni/Mn ratios, and thus does not include the heterogenous formation of the stabilizing coating within the same process step. As such, the present method allows for improvements in scaling and processing over conventional co-precipitation of coated NMC materials by synthesizing a heterogeneous precursor to a Mn-rich spinel coating on the NMC precursor to enhance stability of the Ni-rich cathode powder as compared with uncoated sintered Ni-rich cathode materials. The resulting powder has significantly improved capacity retention (and is thus more stable) under galvanostatic charge/discharge cycling with a high voltage cutoff of 4.5V, at both room temperature and elevated temperatures of 55° C. when compared with unmodified Nickel-rich cathode materials. As such, the co-precipitation method described in various embodiments herein forms a heterogenous precursor composed of transition-metal hydroxides coated with nanoparticles of an Mn-rich material (for example, the composition Mn_{2.7}Co_{0.3}O₄, which may, in some embodiments, be cobalt-doped hausmannite). Reactor conditions and feedstocks are altered during the process to induce nanoparticle formation after hydroxide secondary particle formation, with pH and reaction time being significant factors. The lithiated and sintered cathode maintains a high initial capacity 215 mAh/g due to the Ni-rich base material, and an improvement of capacity retention of over 40% at both 25° C. and 55° C. temperatures when compared with conventional unmodified Nickel-rich cathode materials due to a conformal nanoscale coating of spinel material (e.g., LiMn_{1.8}Co_{0.2}O₄ in certain examples). The coating precursor (in certain examples, composed of a layer of Mn_{2.7}Co_{0.3}O₄ nanoparticles) is synthesized and applied immediately after formation of the NMC811 hydroxide precursor via the co-precipitation method that will be described hereinafter. After sintering, the nanoparticles convert to a conformal nanoscale coating on NMC811. Thus, a heterogeneous cathode precursor is composed of both precursors for core layered and surface spinel components. This contrasts with gradient or core-shell structures, in which only M(OH)₂ particles of different transition metal ion ratios are synthesized.

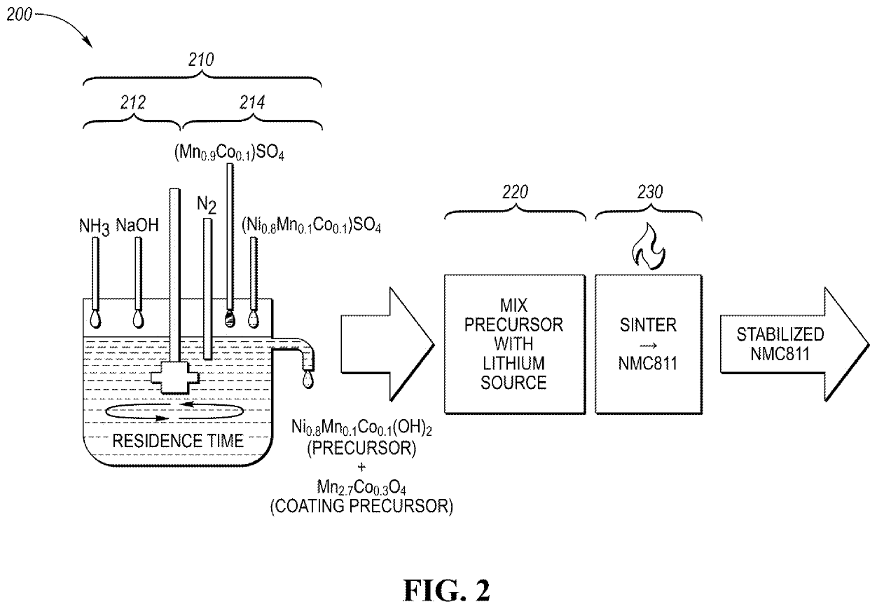

As previously mentioned, although a specific NMC material will be discussed with regard to the Figures and the embodiments provided, the method may be applicable for other cathode active materials that require a stabilization coating, and thus the discussion of Ni-rich materials, NMC materials, Mn-rich spinel, and other stabilization coatings, or particular compositions of the materials, is not intended to be limiting. Thus, in at least one embodiment, as shown in FIGS. 2-5, the Nickel-rich precursor may be NMC hydroxide precursor, such as, for example, a Ni_{0.8}Mn_{0.1}Co_{0.1}(OH)₂ precursor particle, which is co-precipitated such that the precursor particle is coated with nano-particles of spinel precursor, such as a Mn spinel precursor (e.g., Mn_{2.7}Co_{0.3}O₄) via the two-step co-precipitation. Upon sintering, the heterogenous precursor forms a crystalline NMC811 coated with a thin layer of LiMnᵢCoⱼO₄, where i:j=x:y (e.g., for the example of MC91 spinel, LiMn_{1.8}Co_{0.2}O₄), hereinafter interchangeably referred to as the Mn-rich spinel. For the examples describing an MC91 spinel, MC91 refers to the coating composition of Mn:Co=9:1. However, in other embodiments, other coated NMC materials may be formed with various cooperative spinel coatings. For example, cobalt and other doped Mn-rich spinel coatings are also contemplated via the process, and as such, the general description of a spinel precursor or Mn-rich spinel is not intended to be limiting hereinafter, and are used interchangeably, and other materials are contemplated for the spinel precursor.

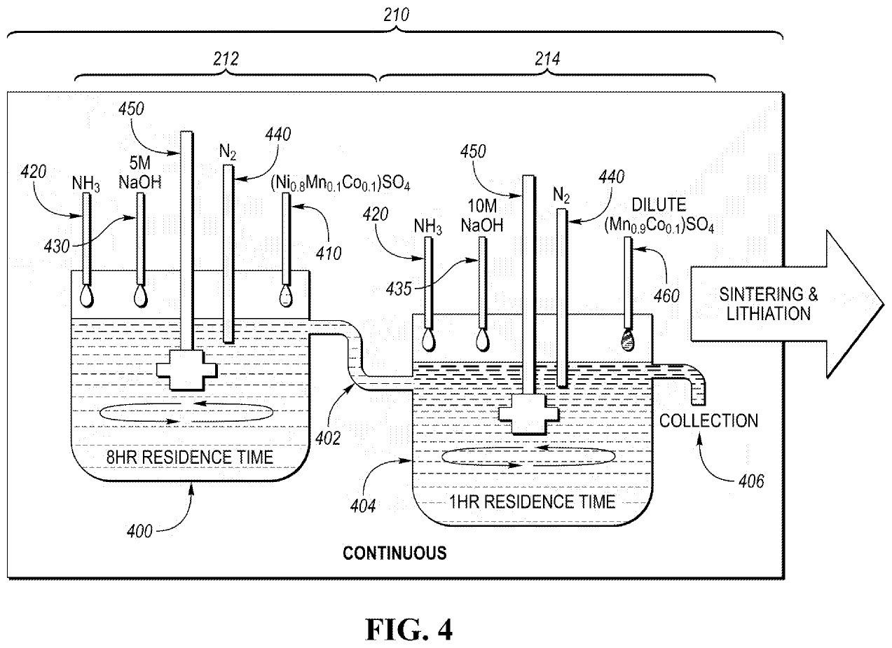

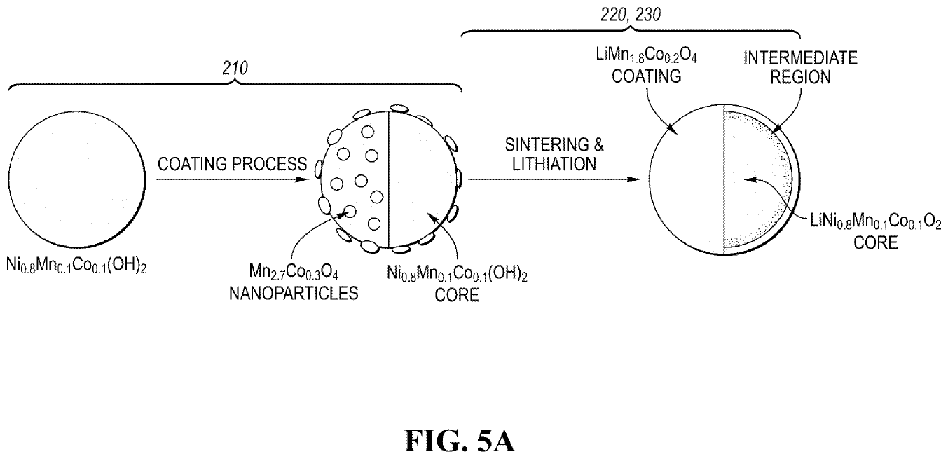

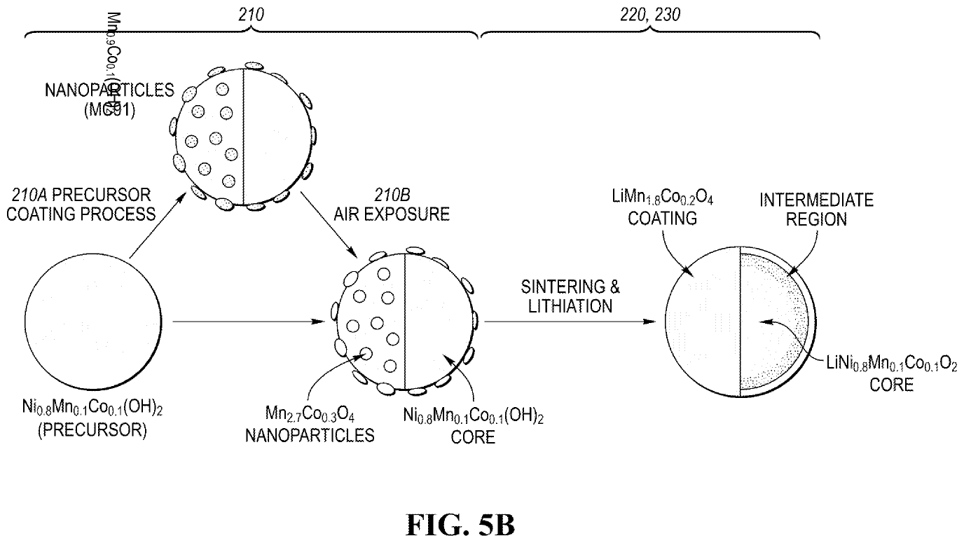

Referring to FIG. 2, a co-precipitation process 200 is used to synthesize a heterogeneous precursor of an NMC transition hydroxide precursor material coated with a Mn-spinel precursor. Although the process is shown for an MC91 spinel, with particular feedstocks and intermediaries, the depiction of the MC91 embodiment is an example of the co-precipitation process, and other spinel precursors may be used with other cathode materials to be coated. Moreover, in some embodiments, other spinel precursors may be used to achieve the MC91 spinel coating, and in other embodiments, other spinel precursors may be used to achieve other Mn-rich spinel coatings or other desired spinel coatings. The heterogenous precursor for the cathode material is formed at step 210 via two-step co-precipitation of the NMC precursor and then the Mn-rich spinel precursor thereon. Co-precipitation of step 210, and the steps 212, 214 that form the two-step process described herein, can be used to formulate spinel precursor-coated NMC precursors at scale. The two-step process includes manipulating the feedstock solutions and reactor pH to form the heterogenous precursor, and may be performed in a batch configuration (as shown in the example of FIG. 4) or in a continuous configuration (as shown in the example of FIG. 5). In one or more embodiments, the reactor is first set with starting material feedstock to form the NMC hydroxide precursor (e.g., (Ni_{0.8}Mn_{0.1}Co_{0.1})(OH)₂) at first step 212 of the co-precipitation step 210, and then the reactor feedstock and pH is modified via addition of spinel precursor (e.g., an Mn-rich material) to form the coating precursor thereon at second step 214, thus establishing the two-step co-precipitation of step 210. In one or more embodiments, the first step 212 may react for a minimum reaction time, as well as include a minimum aging time before the feedstock and/or pH is modified at the second step 214. Moreover, the equipment (e.g., feedstock lines and reactors) may be arranged and the materials and reaction conditions may be modified as based on the configuration of the two-step process (e.g., batch vs. continuous), and the discussion of any type or particular number of feedstocks or reactors is not intended to be limiting. Notably, certain reaction conditions will depend on the particular NMC cathode material desired, as well as the particular coating precursor/spinel desired for stabilization. Although not shown as a separate step in FIG. 2, in one or more embodiments, the co-precipitation process may include exposing the heterogeneous precursor to air to transform a Mn-rich hydroxide to the Mn-rich precursor material.

This heterogeneous precursor is then lithiated at step 220, and sintered thereafter at step 230, to form the stabilized NMC cathode material (e.g., NMC811 in the depicted example of FIG. 2). Thus, although the lithiation and sintering steps 220-230 may be any suitable known lithiation/sintering for cathode NMC materials, the resultant product is stabilized by forming the stabilizing coating via this single sintering step due to the presence of the Mn-rich spinel precursor on the NMC hydroxide precursor particle.

The depiction in FIGS. 2, 3, 4, 5A-5B show examples of the co-precipitation process with reference to compositions and intermediaries for forming an NMC811 cathode with a MC91 spinel coating, and are not intended to be limiting. The co-precipitation method discussed above and hereinafter may be used for other spinel coatings on other cathode materials, and discussion of the MC91 or other Mn-rich spinel coatings, feedstock, and precursor materials, and NMC811, is described an example of the process. In the embodiment shown in FIG. 2, for forming an NMC811 cathode material with a spinel coating having the formula MnCoxy, where x+y=10 and x:y>=1 the reactor at step 210 is provided with feedstocks providing starting materials for the Nickel-rich cathode material precursor (e.g., a NMC material, such as, in the depicted example, Ni_{0.8}Mn_{0.1}Co_{0.1})SO₄), NH₃, starting materials for the Mn-rich spinel precursor (e.g., Mn_{g}Coₕ(OH)₂, where g:h=x:y, and in the example shown, having the formula Mn_{0.9}Co_{0.1}1SO₄), and NaOH, with the reactor being stirred and bubbled with a gas (such as N₂) to form the heterogenous precursor material of the NMC hydroxide precursor (e.g., of Ni_{0.8}Mn_{0.1}Co_{0.1}(OH)₂ in the examples shown) coated with a Mn-coating precursor (e.g., MnₑCo_{f}O₄, where e:f=x:y, and in the example shown,).

Although not shown in FIG. 2, upon precipitation and drying of the precipitation product and exposure to air, the heterogeneous precursor is formed. Thereafter, the precursor materials undergo the lithiation and sintering (e.g., under a slight molar excess (3-5 mol % excess) of lithium-hydroxide under flowing oxygen, or as sintering with an initial Li/Transition Metal ratio of, in some embodiments, 1.00 to 1.10, in other embodiments, 1.02 to 1.08, or in yet other embodiments, 1.03 to 1.05) to form the NMC811 cathode material with the Mn-rich spinel coating. In the example of FIG. 2, as discussed with respect to examples of particular compositions, the Mn-rich spinel coating may be LiMn₂ᵢCo₂ⱼO₄, where i:j=x:y, shown in the examples of the Figures as LiMn_{1.8}Co_{0.2}O₄ which arranges in the spinel Fd3m structure, thus containing an interstitial network for lithium diffusion, as opposed to higher impedance materials. This material can be milled or ground to form the cathode powder to be used in slurry casting the cathode by suitable conventional methods.

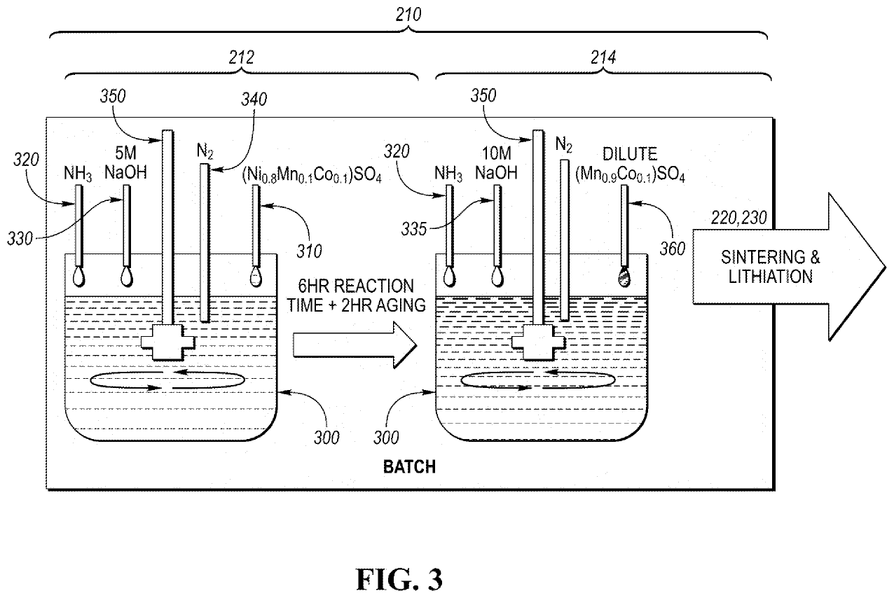

Referring to FIG. 3, the two-step co-precipitation step 210 is shown according to an example. The two-step co-precipitation can be conducted in large scale (e.g., on a kilogram scale via a batch reaction process, as is shown in FIG. 3. In one or more embodiments, the transition metal hydroxide precursors are synthesized using a co-precipitation method in a reactor, including but not limited to a glass jacketed reactor 300, utilizing feedstock solutions of transition metal sulfates 310, a chelating agent 320 (e.g., ammonia (NH₃)), and a solution 330 for controlling the pH as reactant feedstocks. In at least one embodiment, the chelating agent is a 3.5M solution of ammonia which complexes with the transition metal ions to control the rate of metal hydroxide precipitation such that spherical particles are formed during step 212. The transition metal sulfates feedstock solution 310 may have any suitable composition and concentration as based on the desired Ni-rich cathode material. In at least one embodiment, the metal sulfate feedstock for step 212 is a 1.8M metal sulfate feedstock solution composed of NiSO₄, MnSO₄, and CoSO₄ dissolved in deionized water in a 8:1:1 molar ratio. Although specific molarities and ratios are provided, any suitable molar concentration may be used as dependent on the desired reactants, and the discussion of specific concentrations is not intended to be limiting.

When the process is conducted as a batch process, the reactor may be a reactor initially filled with a volume of an ammonia solution (less concentrated than the chelating agent 320 solution), and stirred via stirrer 350 while kept at a constant temperature (e.g., via a heated water pump), with a gas 340, such as nitrogen or other inert gas, being continuously bubbled into the reactor to establish an inert atmosphere. A more concentrated ammonia solution and the metal sulfate feedstock solution are then added dropwise at a predetermined rate for a predetermined amount of time into the reactor to reach a specific composition within the reactor. The pH of the reactor contents is maintained at a constant value using a pH controller and a solution 330 of sodium hydroxide, or other suitable base, to adjust pH. In at least one embodiment, the constant value of the pH of the reactor contents may be 10 to 12, in other embodiments 10.5 to 11.5, and in yet other embodiments, 11.0±0.1.

In order to produce NMC hydroxide precursors, the reaction is allowed to continue during step 212 for a predetermined reaction period of time, followed by predetermined aging time during which the pH is kept constant while no additional metal sulfates or ammonia is added to the reactor. For example, in at least one embodiment, the predetermined reaction period of time may be 6 hours and the aging time may be 2 hours. The reactor contents will have changed from the sulfate-based feedstock solution to a more dilute solution of the Mn-rich coating starting material 360 after the aging time, with the Mn-rich feedstock starting material 360 being prepared to be supplied via a feedstock. After the aging step, at step 214, the pH of the reactor contents is adjusted and maintained at this new pH level using a more basic solution 335 (e.g., sodium hydroxide, or other suitable base), in order to increase the reaction driving force and facilitate nanoparticle formation. In at least one embodiment, the new pH level may be 11 to 13, in other embodiments, 11.8 to 12.8, and in yet other embodiments, 12.5±0.1. The Mn-rich coating feedstock starting material 360 and the more concentrated ammonia solution 320 are added dropwise at a predefined rate for a predefined amount of time to reach a specific composition of the heterogenous precursor before collection. The precipitated product is washed several times with deionized water, dried (e.g., at elevated temperature in air), and then filtered (e.g., through a sieve) to form the NMC hydroxide precursor with Mn-rich hydroxide precursor nanoparticles thereon. Upon exposure to air, the Mn-rich hydroxides on the surface quickly oxidize into the Mn-rich precursor material. (e.g., Mn_{2.7}Co_{0.3}O₄ nanoparticles which turn from light brown in color to dark brown for the MC91 spinel example shown in the Figures). Although the above components are described for a batch process, the process can be modified to a continuous reactor set up, as shown in the example of FIG. 4, including two separate reactors in fluid connection to allow the contents of the first reactor to flow to the second reactor, with the feedstocks corresponding to each step of the two-step co-precipitation corresponding to each reactor.

After drying in air, the heterogeneous precursor is lithiated at step 220, such as by being mixed thoroughly with a lithium source. In one or more embodiments, the lithium source, such as lithium hydroxide monohydrate, is supplied with a slight excess of lithium to account for partial vaporization of lithium and to minimize cation mixing during initial sintering. Thereafter, at step 230, sintering is conducted in a furnace (e.g., a tube furnace) under oxygen flow, with a two-step process at a first temperature for a first period of time, and a second temperature for a second period of time, the first temperature being lower than the second temperature, and the second period of time being longer than the first period of time. After the sintering step, the resulting cathode powder is may be ground gently to remove agglomerates, and sieved again to form a resulting powder that can now be used as cathode powder in a conventional slurry casting process.

Referring to FIG. 4 the two-step co-precipitation step 210 is shown according to another example. The two-step co-precipitation can be conducted in large scale (e.g., on a kilogram scale) via a continuous reactor process. In one or more embodiments, the transition metal hydroxide precursors are synthesized using a co-precipitation method in continuous reactors 400, 404 which are fluidly connected via fluid channel 402. The reactors 400, 404 (hereinafter first reactor 400 and second reactor 404) may be any suitable type of reactor, including, but not limited to a glass jacketed reactor. Each of the first and second reactors 400, 404 includes inlets for feedstock solutions of transition metal sulfates 410, a chelating agent 420 (e.g., ammonia (NH₃)), and a solution 430 for controlling the pH as reactant feedstocks. In at least one embodiment, the chelating agent is a 3.5M solution of ammonia which complexes with the transition metal ions to control the rate of metal hydroxide precipitation such that spherical particles are formed during step 212. The transition metal sulfates feedstock solution 410 may have any suitable composition and concentration as based on the desired Ni-rich cathode material. In at least one embodiment, the metal sulfate feedstock for step 212 is a 1.8M metal sulfate feedstock solution composed of NiSO₄, MnSO₄, and CoSO₄ dissolved in deionized water in a 8:1:1 molar ratio.

The first reactor is stirred via stirrer 450 at a constant temperature with a gas 440, such as nitrogen or other inert gas, being continuously bubbled into the reactor to establish an inert atmosphere while the ammonia solution and the metal sulfate feedstock solution are added dropwise at a predetermined rate into the reactor to reach a specific composition within the reactor. The pH of the reactor contents of the first reactor 400 is maintained at a constant value (e.g., 10 to 12 in certain embodiments, 10.5 to 11.5 in other embodiments, and in yet other embodiments, 11.0±0.1) using a pH controller and a solution 430 of sodium hydroxide, or other suitable base solution, to adjust pH.

In order to produce NMC hydroxide precursors, the reaction is allowed to continue during step 212 for a predetermined residence period of time in the first reactor 400, followed by predetermined residence time in the second reactor 404 at the different pH with the additional feedstock of the Mn-rich starting material 460. For example, in at least one embodiment, the predetermined residence period in the first reactor 400 may be 5 to 10 hours, in some examples, 6 to 9 hours in other examples, and 6.5 to 8.5 hours in other examples, and predetermined residence period in the second reactor 404 may be in some examples, 0.5 to 3 hours, in other examples 0.75 to 2.5 hours, and in yet other examples 1 to 2 hours. In certain embodiments, the predetermined residence period in the first reactor 400 may be 8 hours, and the predetermined residence period in the second reactor 404 may be 1 hour.

As the contents flow from the first reactor 400 to the second reactor 404, the contents will have changed from the sulfate-based feedstock solution to a more dilute solution of the Mn-rich coating starting material 360 after the residence period, with the Mn-rich coating feedstock starting material 360 being prepared to be supplied via a feedstock at the second reactor 404 during step 214. The pH of the second reactor 404 is adjusted to 11 to 13 in some examples, 11.8 to 12.8 in other examples, and 12.5±0.1 in yet other examples, and maintained at this new pH level using a more basic solution 435 (e.g., sodium hydroxide, or other suitable base) than the solution 430, in order to increase the reaction driving force and facilitate nanoparticle formation. The Mn-rich coating feedstock starting material 360 and the more concentrated ammonia solution 320 are added dropwise at a predefined rate to the second reactor 404 to achieve a specific composition of the heterogenous precursor for collection.

The precipitated product is washed several times with deionized water, dried (e.g., at elevated temperature in air) and, then filtered (e.g., through a sieve) to form the NMC hydroxide precursor with Mn-rich hydroxide precursor nanoparticles thereon. Upon exposure to air, the Mn-rich hydroxides on the surface quickly oxidize into the Mn-rich precursor spinel (e.g., MnₑCo_{f}O₄, nanoparticles, in which e:f=x:y, which correlates with a visible change from light brown in color to dark brown. In the example shown in the Figures, light brown Mn_{0.9}Co_{0.1}(OH)₂ is changed into dark brown Mn_{2.7}Co_{0.3}O₄ nanoparticles upon oxidation in air at elevated temperatures.

After drying in air, the heterogeneous precursor is lithiated at step 220, such as by being mixed thoroughly with a lithium source. In one or more embodiments, the lithium source, such as lithium hydroxide monohydrate, is supplied with a slight excess of lithium to account for partial vaporization of lithium and to minimize cation mixing during initial sintering. Thereafter, at step 230, sintering is conducted in a furnace (e.g., a tube furnace) under oxygen flow, with a two-step process at a first temperature for a first period of time, and a second temperature for a second period of time, the first temperature being lower than the second temperature, and the second period of time being longer than the first period of time. After the sintering step, the resulting cathode powder is may be ground gently to remove agglomerates, and sieved again to form a resulting powder that can now be used as cathode powder in a conventional slurry casting process.

In various embodiments, the parameters and reaction conditions may be varied, for example, the coating process reaction time may be increased or decreased based on the desired nanoparticle formation. As such, the coating layer may be thicker or thinner depending on coating reaction time, thus impacting overall performance. Moreover, initial hydroxide precursor formation can be influenced by reaction time, and larger size particles with more spherical shape can be produced under longer reaction times. Furthermore, in various embodiments, the composition of both base material (e.g., the Ni-rich starting material) and stabilizing coating material (Mn-coating starting material) can be changed to other suitable cathode active materials and stabilizing coatings. Moreover, the concentration of the coating solutions and feedstocks may be adjusted to be more dilute or more concentrated as based on the desired precipitation of particles. In at least one embodiment, the pH may be increased with the inclusion of a stronger base to maintain the pH of the reaction process. Additionally, in certain embodiments, the atmosphere of the reactor may be bubbled air instead of bubbled nitrogen, or another inert gas, which can produce a different coating precursor prior to lithiation/sintering. For example, in certain variations of the example shown, the precursor may be pyrolusite Mn_{1.8}Co_{0.2}O₂ rather than hausmannite Mn_{2.7}Co_{0.3}O₄, which will produce the same final coating material on the NMC material under lithiation and sintering.

As is shown in the schematic illustration of FIG. 5A, the process of coating the NMC hydroxide precursor with the Mn-coating precursor is schematically shown, with reference to the MC91 example of FIGS. 2-4, which is not intended to be limiting. In the embodiment shown in FIG. 5B, the spinel coating precursor after co-precipitation may be Mn_{g}Coₕ(OH)₂ where g:h=x:y (e.g., shown as Mn_{0.9}Co_{0.1}(OH)₂) on the NMC hydroxide precursor, for the example of MnCoxy spinel coatings, and the additional air exposure step to form the heterogeneous precursor (e.g., Mn_{2.7}Co_{0.3}O₄ nanoparticle precursor on the NMC precursor core) is also shown, as will be discussed in detail with reference to FIG. 5B. Referring again to FIG. 5A, the NMC hydroxide precursor (e.g., of Ni_{0.8}Mn_{0.1}Co_{0.1}(OH)₂) may be a spherical particle coated with nanosized particles of the Mn-coating precursor (e.g., Mn_{2.7}Co_{0.3}O₄) as formed during step 210 Although shown as spherical particles on the spherical NMC hydroxide precursor, the coating precursor may be on the NMC hydroxide precursor in any suitable form, including but not limited to flakes, ovals, ellipses, rectangles, tubes, wires, layers, or other suitable forms of coating on the core particle such that the nanoparticles can be sintered to form a generally continuous coating over the active material spherical particle as a thin layer Mn-rich coating. Thus, upon lithiation and sintering at steps 220, 230, the stabilized active material particle is formed with a core region of NMC (e.g., NMC811) and the Mn-rich spinel coating of MnCo_{xy}(e.g., MC91), with an intermediate region therebetween comprised of a Ni-rich core material with diffused spinel coating therein.

Referring to FIG. 5B, the step 210 of forming the NMC precursor with the coating precursor is shown in greater detail according to one or more embodiments. During the formation process at step 210a (which includes steps 212 and 212 of the co-precipitation method), the NMC hydroxide precursor (e.g., (Ni_{0.8}Mn_{0.1}Co_{0.1})(OH)₂) is formed from the starting materials, with Mn-rich nanoparticles thereon (e.g., MC91 nanoparticles (i.e., Mn_{0.9}Co_{0.1}(OH)₂, formed from the starting materials of Mn_{0.9}Co_{0.1}SO₄)). At step 210b, after the precursor materials have been coprecipitated, the spinel precursor nanoparticles (e.g., MC91 spinel precursor) are converted to Mn_{2.7}Co_{0.3}O₄ precursor nanoparticles in air to form the heterogenous precursor for lithiation and sintering at steps 220, 230. The nanoparticles may have any suitable size, as may be based on the desired reaction and precipitation time. In some examples, the nanoparticles may be less than 50 nm in diameter.

In one or more embodiments, the coating on the NMC material may be further doped with cobalt or another metal to further stabilize the structural stability of the spinel coating and improve charge-transfer kinetics. The doping process includes altering the coating sulfate solution composition (i.e., the spinel precursor). For example, the coating sulfate solution may be MnₖM₍₁₋ₖ₎SO₄, where M is one or more of Co, Mg, Ti, Ni, Al, Fe, Cu, and 0<k<0.5.

Experimental Example

In an example, transition metal hydroxide precursors are synthesized using a co-precipitation route in a 1 L glass jacketed reactor, utilizing solutions of transition metal sulfates, ammonia, and sodium hydroxide as reactants. A 3.5M solution of ammonia functions as a chelating agent, complexing with transition metal ions to control the rate of metal hydroxide precipitation to allow for the formation of spherical secondary particles. The initial 1.8M metal sulfate feedstock solution is composed of NiSO₄, MnSO₄, and CoSO₄ dissolved in deionized water in a 8:1:1 molar ratio. The 1 L reactor is initially filled with 500 mL of a 2.75M solution of ammonia and stirred at 650 RPM at 55° C. via heated water circulating in the reactor glass jacket, with nitrogen gas continuously bubbled into the reactor to establish an inert atmosphere. The 3.5M solution of ammonia and 1.8M metal sulfate solution are then added dropwise into the reactor at 0.55 mL/min and 0.17 mL/min, respectively. The pH is maintained at a constant value of 11.0±0.1 using a pH controller and a 5M solution of sodium hydroxide to adjust pH. To produce NMC811 hydroxide precursors, the reaction is allowed to continue for 6 hours, followed by an aging time of 2 hours in which the pH is kept constant while no additional metal sulfates or ammonia is added to the reactor. Afterwards, the initial feedstock solution of Ni_{0.8}Mn_{0.1}Co_{0.1}SO₄ is changed into a more dilute 0.5M solution of Mn_{0.9}Co_{0.1}SO₄ after the 2-hour aging step. The pH setting is adjusted to 12.5±0.1 and maintained using a 10M solution of sodium hydroxide in order to increase the reaction driving force and facilitate nanoparticle formation. The new reactants and 3.5M ammonia solution are added dropwise at 0.55 mL/min and 0.17 mL/min, respectively, for 1 hour and left to age for several hours before collection. The product is washed several times with DI water, dried at 80° C. in air in a convection oven, then filtered through a 38 μm sieve. Upon exposure to air, the Mn-rich hydroxides on the surface quickly oxidize into Mn_{2.7}Co_{0.3}O₄ nanoparticles, turning the powder from a typical light brown to a dark brown.

After drying in air, the transition metal precursor is mixed thoroughly with lithium hydroxide monohydrate in a 1.00:1.05 molar ratio (Li/TM=1.05). A slight excess of lithium is required to account for partial vaporization of lithium and to minimize cation mixing during initial sintering. Sintering is conducted in a tube furnace under oxygen flow, with a two-step process of 450° C. for 6 hrs, followed by 775° C. for 15 hrs, with heating and cooling rates set to 2° C./min. Afterwards the resulting cathode powder is ground gently to remove agglomerates, sieved again through a 38 μm sieve, and the resulting powder can now be used as cathode powder in a conventional slurry casting process.

Thus, according to one or more embodiments, a two-step coprecipitation method of forming a heterogenous precursor of a NMC hydroxide precursor coated with an Mn-rich stabilizing coating precursor is provided. The heterogeneous precursor can be lithiated and sintered to form a stabilized coated NMC cathode material. The two-step processes for co-precipitation includes adjusting the feedstock and pH of the reactor to form the NMC hydroxide precursor followed by the Mn-rich hydroxide intermediary, which is converted to the Mn-rich precursor upon exposure to air. The two-step process allows for the production of the coated NMC cathode materials to be scaled to form large amounts of stabilized cathode materials in either batch or continuous processes, and increases the stability of the NMC cathode material as compared with pristine NMC materials. Although described in the Figures with reference to compositions for an MC91 spinel, other spinel precursors and cathode materials are contemplated via the co-precipitation process, and the description of the MC91 spinel co-precipitation is not intended to be limiting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of stabilizing Nickel-rich (NMC) cathode materials comprising:
mixing a feedstock of transition metal sulfates, ammonia, and a basic solution to under bubbling of an inert gas to form a reaction solution;
precipitating transition metal hydroxide particles from the reaction solution over a first period of time to precipitate the transition metal hydroxide particles therein to form a metal sulfate solution;
altering a pH of the metal sulfate solution;
supplying a Mn-rich feedstock to the metal sulfate solution to form a Mn-rich solution; and
precipitating Mn-rich hydroxide nanoparticles from the Mn-rich solution onto surfaces of the transition metal hydroxide particles over a second period of time to form a heterogeneous precursor.

2. The method of claim 1, wherein the precipitating step includes exposing the heterogeneous precursor to air to transform the Mn-rich hydroxide nanoparticles to Mn-rich precursor nanoparticles.

3. The method of claim 2, wherein the Mn-rich precursor nanoparticles are Mn_{2.7}Co_{0.3}O₄, the Mn-rich hydroxide nanoparticles are Mn_{0.9}Co_{0.1}(OH)₂, and the transition metal hydroxide particles are (Ni_{0.8}Mn_{0.1}Co_{0.1})(OH)₂.

4. The method of claim 1, wherein the precipitating is conducted via a batch process such that the first period of time includes a precipitation period and an aging period such that the transition metal hydroxide particles are precipitated therein during the precipitation period.

5. The method of claim 1, wherein the first period of time and the second period of time occur in separate fluidly connected reactor vessels as a respective first and second residence time of a continuous process.

6. The method of claim 1, wherein the inert gas is nitrogen and the basic solution is sodium hydroxide.

7. The method of claim 1, wherein the altering the pH is via addition of a basic feedstock more concentrated than the basic solution.

8. A method of stabilizing Nickel-rich (NMC) cathode materials comprising:
mixing a feedstock of transition metal sulfates, ammonia, and a basic solution to under bubbling of an inert gas to form a reaction solution at a first pH;
precipitating transition metal hydroxide particles from the reaction solution over a first period of time to form a metal sulfate solution;
altering the first pH of the metal sulfate solution to a second pH, higher than the first pH;
supplying a Mn-rich feedstock to the metal sulfate solution to form a Mn-rich solution;
precipitating Mn-rich hydroxide nanoparticles from the Mn-rich solution onto surfaces of the transition metal hydroxide particles over a second period of time;
exposing the Mn-rich hydroxide nanoparticles to air to form a heterogeneous precursor; and
lithiating the heterogeneous precursor with a lithium source to form a stabilized nickel-rich material.

9. The method of claim 8, wherein the heterogeneous precursor includes a Mn-rich precursor coated on a transition metal hydroxide particle.

10. The method of claim 9, wherein the Mn-rich hydroxide nanoparticles are Mn_{0.9}Co_{0.1}(OH)₂ and the Mn-rich precursor is Mn_{2.7}Co_{0.3}O₄.

11. The method of claim 8, wherein the precipitating steps are via a batch process such that the first period of time and second period of time occur within the same reaction vessel.

12. The method of claim 11, wherein the first period of time includes a precipitation period and an aging period and the transition metal hydroxide particles are precipitated during the precipitation period.

13. The method of claim 8, wherein altering the pH includes adding a basic feedstock more concentrated than the basic solution to the metal sulfate solution to change the pH to the second pH.

14. The method of claim 8, wherein the stabilized nickel-rich material is a Mn-rich spinel coated NMC811.

15. The method of claim 8, wherein the transition metal hydroxide particles are NMC811 precursor particles having the formula Ni_{0.8}Mn_{0.1}Co_{0.1}(OH)₂.

16. The method of claim 8, wherein the Mn-rich feedstock is doped with cobalt.

17. A method of stabilizing Nickel-rich (NMC) cathode materials comprising:
mixing a feedstock of transition metal sulfates, ammonia, and sodium hydroxide solution to under bubbling of an inert gas to precipitate transition metal hydroxide particles from the reaction solution over a first period of time at a first pH to form a metal sulfate solution;
altering the first pH to a second pH higher than the first by adding a sodium hydroxide feedstock more concentrated than the sodium hydroxide solution to the metal sulfate solution;
supplying a Mn-rich feedstock to the metal sulfate solution to form a Mn-rich solution;
precipitating Mn-rich hydroxide nanoparticles from the Mn-rich solution onto surfaces of the transition metal hydroxide particles over a second period of time;
exposing the Mn-rich hydroxide nanoparticles to air to form a heterogeneous precursor having an Mn-rich precursor coated on the transition metal hydroxide particles; and
lithiating the heterogeneous precursor with a lithium source to form a stabilized nickel-rich material.

18. The method of claim 17, wherein the precipitating steps are conducted within the same reactor vessel as a batch process such that the first period of time includes a precipitation time period and an aging time period.

19. The method of claim 17, wherein the precipitating steps are conducted as a continuous process such that the first period of time is within a first reactor and the second period of time is in a second reactor, fluidly connected to the first.

20. The method of claim 17, where the first pH is 10-12 and the second pH is 11-13.
